(19) United States
(12) Patent Application Publication
(10) Pub. No.: US 2015/0318966 A1
(43) Pub. Date: Nov. 5, 2015

(54) RADIO COMMUNICATION SYSTEM AND COMMUNICATION CONTROL METHOD

(71) Applicants: Le LIU, Minato-ku, Tokyo (JP); Naoto ISHII, Minato-ku, Tokyo (JP); NEC Corporation

(72) Inventors: Le LIU, Tokyo (JP); Naoto ISHII, Tokyo (JP)

(73) Assignee: NEC Corporation

(21) Appl. No.: 14/649,171

(22) PCT Filed: Dec. 5, 2012
(86) PCT No.: PCT/JP2012/007791

§ 371 Date: Jun. 2, 2015

(51) Int. Cl. H04L 5/00; H04W 72/12

(52) U.S. Cl. CPC H04L 5/0035; H04W 72/1231; H04L 5/0073

(57) ABSTRACT

A radio communication system achieving reduction in interference variation can be provided. In a radio communication system includes a plurality of radio nodes each capable of communicating with a user equipment, wherein at least one radio node includes a scheduler which collects the neighbor node information from neighbor radio nodes and performs coordinated scheduling of multiple coordinated radio nodes using the neighbor node information, wherein the neighbor node information includes information related to the transmit power of the neighbor radio nodes.

### TECHNICAL FIELD

The present invention relates generally to a radio communication system and, more specifically, to techniques of coordinated scheduling in coordinated multi-point (CoMP) transmission/reception scheme.

### BACKGROUND ART

Coordinated multi-point transmission/reception is considered in LTE (Long Term Evolution)-Advanced Release 11(Rel. 11) as a tool to improve the coverage of high data rates, the cell-edge throughput, and also to increase the system throughput as described in the Sect. 4 of NPL1.

The CoMP schemes, joint transmission (JT), dynamic point selection (DPS), and coordinated scheduling/coordinated beamforming (CS/CB) have been agreed to be supported as described in the Sect. 5.1.3 of NPL1. For JT, multiple transmission points (TPs) are selected for simultaneous data transmission and the interference comes from the points other than the selected TPs. For DPS, only one TP is dynamically selected and the interference comes from the points other than the only selected TP. While, for CB/CS, the serving point is the only TP to transmit data but the strong interference from the neighbor cell is reduced significantly.

In NPL2, a set of CSI-RS resources is defined as a CoMP resource management set, for which CSI-RS received signal measurement can be made and reported. Within the CoMP resource management set, a CoMP measurement set is defined in the Sect. 5.1.4 of NPL1 as a set of points about which channel state/statistical information (CSI) related to their link to a user equipment (UE) is measured and/or reported. For CoMP, the CSI considering the interference power with or without muting on different cells in the CoMP measurement set needs to be estimated at UE side and fed back by the UE to the network. The obtained CSI is used for channel-dependent scheduling to support the above CoMP schemes among multiple coordinated points in the CoMP measurement set. In the present specification, a point for coordinated multi-point transmission/reception can be used as a technical term including a cell, base station, Node-B, eNB, remote radio equipment (RRE), distributed antenna, and the likes.

As illustrated in FIG. 1, it is assumed that Macro eNB and low power nodes LPN1 and LPN2, connected by optical fiber (backhaul), are grouped into a CoMP cooperating set for centralized scheduling at Macro eNB. Here, a CoMP resource management set is set large enough to include the Macro eNB and LPNs within the Macro area. Within the CoMP resource management set, a UE-specific CoMP measurement set can be decided based on RSRP. In FIG. 2, UE1's CoMP measurement set includes its serving point LPN1 and neighbor point Macro eNB; while UE2's CoMP measurement set includes only its serving point LPN2.

Conventionally, the received reference signal measurements are made and reported for CoMP scheduling which includes CoMP measurement set decision and channel-dependent scheduling of dynamic resource allocation.

For the CoMP measurement set decision, the long-term measurements of received reference signals are made and reported by UE to its serving cell. For example, the reference signal received power (RSRP) defined in Sect. 5.1.1 of NPL3, is used for CoMP measurement set decision. As shown in FIG. 2, only the neighbor point satisfying that the difference between serving cell's RSRP, RSRPₛₑᵣᵥ, and neighbor cell's RSRP, RSRP_{neigh}, is smaller than a pre-defined threshold TH_{RSRP}, will be included in the CoMP measurement set, i.e., RSRPₛₑᵣᵥ−RSRP_{neigh}<TH_{RSRP}.

For channel-dependent scheduling of resource allocation, the short-term CSI obtained from the received reference signals is measured and reported by UE to its serving cell. The short-term CSI feedback includes the channel quality indicator (CQI), precoding matrix index (PMI) and rank indicator (RI) defined in NPL1. For centralized scheduling, each UE's CSI feedback should be aggregated from its serving cell to the centralized scheduler at Macro eNB.
{NPL1 } 3GPP TR 36.819 v11.0.0, Coordinated multi-point operation for LTE physical layer aspects (Release 11).
http://www.3gpp.org/ftp/Specs/archive/36_series/36.819/.
{NPL2} R1-123077, LS on CSI-RSRP and CoMP Resource Management Set,
(http://www.3gpp.org/ftp/tsg_ran/WG1_RL1/TSGR1_{—}69/Docs/)
{NPL3} 3GPP TR 36.214 v11.0.0, Physical Channels and Modulation of Evolved Universal Terrestrial Radio Access (E-UTRA); Physical layer;
Measurements (Release 11).
http://www.3gpp.org/ftp/Specs/archive/36_series/36.214/.

### SUMMARY

### Technical Problem

However, the employment of CoMP under non-full-buffer traffic, e.g., bursty traffic, may further increase interference variations and significantly degrade the user throughput of UEs other than the CoMP UE. A simple example of such interference in a system with the employment of CoMP is shown in FIG. 3.

In FIG. 3, it is assumed that a UE_A, served by low power node LPN_A, has a CoMP measurement set including its serving cell LPN_A and Macro eNB_A. Before applying CoMP under non-full-buffer traffic, the high transmit power at Macro eNB_A may be switched off. After applying CoMP, the high transmit power at Macro eNB_A is turned on for the UE_A. However, such a high transmit power at Macro eNB_A results in strong interferences to other UEs (UE_B and UE_C served by neighbor Macro eNB_B and Macro eNB_C, respectively). In other words, although the user throughput of the UE_A is improved by turning on the high transmit power of Macro eNB_A, the user throughput of other UEs is degraded significantly.

### Solution to Problem

An object of the present invention is to provide a radio communication system and communication control method which can reduce the degradation of user throughput of other UEs resulted from the interference variation due to the CoMP employment to a CoMP UE.

According to the present invention, a radio communication system includes a plurality of radio nodes each capable of communicating with a user equipment, wherein at least one radio node comprises a scheduler which collects the neighbor node information from neighbor radio nodes and performs coordinated scheduling of multiple coordinated radio nodes using the neighbor node information, wherein the neighbor node information includes the information related to the transmit power of the neighbor radio nodes.

According to the present invention, a method for controlling communication of a radio node in a radio communication network including a plurality of radio nodes each capable of communicating with a user equipment, includes the steps of: collecting the neighbor node information from neighbor radio nodes; and performing coordinated scheduling of multiple coordinated radio nodes using the neighbor node information, wherein the neighbor node information includes the information related to the transmit power of the neighbor radio nodes.

According to the present invention, a radio node of a radio communication network including a plurality of radio nodes each capable of communicating with a user equipment, includes a scheduler which collects the neighbor node information from neighbor radio nodes and performs coordinated scheduling of multiple coordinated radio nodes using the neighbor node information, wherein the neighbor node information includes the information related to the transmit power of the neighbor radio nodes.

### Advantageous Effects

According to the present invention, coordinated scheduling of multiple coordinated radio nodes can be performed by using the information related to the transmit power of the neighbor radio nodes, reducing the degradation of user throughput of other UEs resulted from the interference variation due to the CoMP employment to a CoMP UE.

For a more complete understanding of the present disclosure and its advantages, reference is now made to the following description taken in conjunction with the accompanying drawings, in which like reference numerals represent like parts:

### BRIEF DESCRIPTION OF DRAWINGS

FIG. 1 is a schematic diagram illustrating a radio communication system for explanation of CoMP cooperating set and CoMP measurement set.

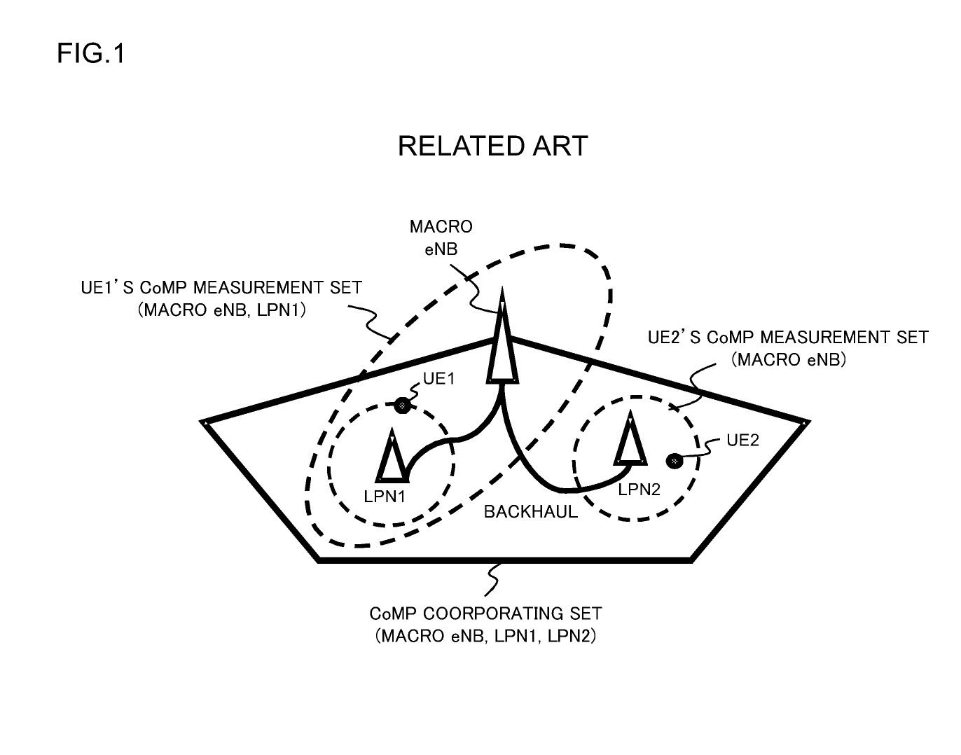

FIG. 2 is a diagram illustrating RSRP for each cell for explanation of RSRP-based decision of CoMP measurement set.

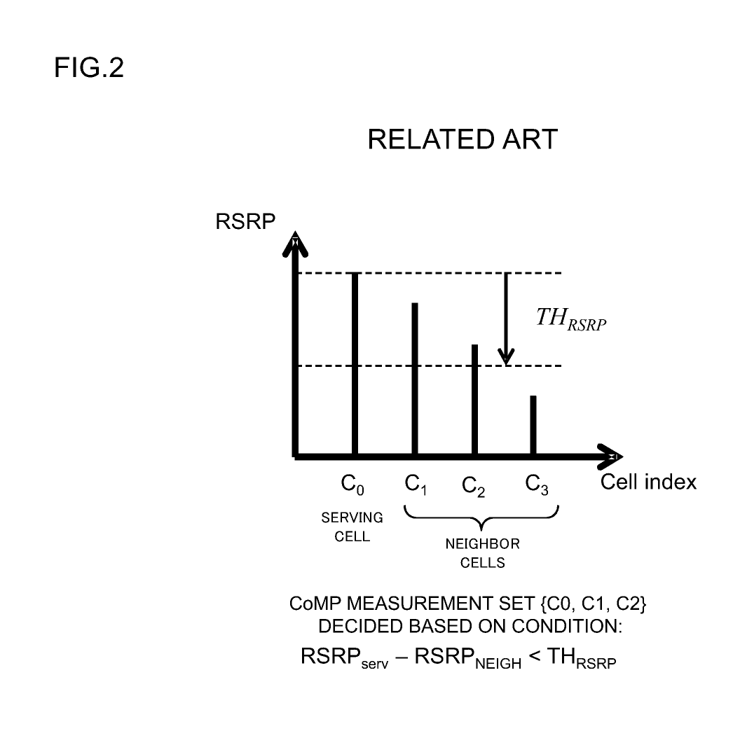

FIG. 3 is a schematic diagram illustrating interference variations of a conventional radio communication system.

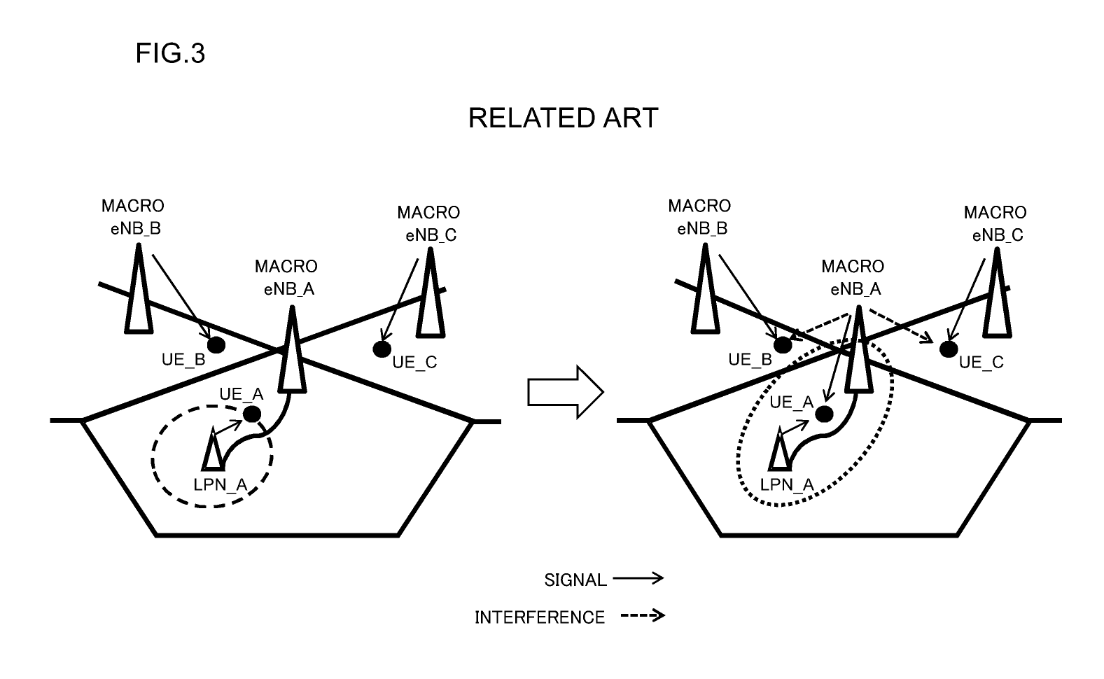

FIG. 4 is a schematic diagram illustrating a radio communication system with centralized scheduling scheme according to an embodiment of the present invention.

FIG. 5 is a schematic diagram illustrating a radio communication system with distributed scheduling scheme according to an embodiment of the present invention.

FIG. 6 is a schematic diagram illustrating a radio communication system according to a first exemplary embodiment of the present invention.

FIG. 7 is a flowchart illustrating a CoMP measurement set decision procedure in a coordinated scheduling method according to a first example of the present invention.

FIG. 8 is a flowchart illustrating a CoMP measurement set decision procedure in a coordinated scheduling method according to a second example of the present invention.

FIG. 9 is a flowchart illustrating a resource allocation procedure in a coordinated scheduling method according to a third example of the present invention.

FIG. 10 is a flowchart illustrating a resource allocation procedure in a coordinated scheduling method according to a fourth example of the present invention.

FIG. 11 is a schematic diagram illustrating a radio communication system according to a second exemplary embodiment of the present invention.

FIG. 12 is a flowchart illustrating a CoMP measurement set decision procedure in a coordinated scheduling method according to fifth and sixth examples of the present invention.

FIG. 13 is a flowchart illustrating a resource allocation procedure in a coordinated scheduling method according to seventh and eighth examples of the present invention.

### DETAILED DESCRIPTION

### 1. OUTLINES OF THE INVENTION

According to an embodiment of the present invention, coordinated scheduling is performed by using the neighbor point information collected from coordinated points, reducing the degradation of user throughput of other UEs resulted from the interference variation due to the CoMP employment to a CoMP UE. The neighbor point information includes the information related to a magnitude of the transmit power of the coordinated points, which may further include the information related to traffic load of the coordinated points. The coordinated scheduling may include at least one of the following processes:

1) CoMP measurement set decision based on not only the RSRP (reference signal received power) but also the neighbor point information;

2) Channel-dependent scheduling of resource allocation based on not only the CSI (channel state/statistical information) feedback but also the neighbor point information.

The coordinated scheduling is performed taking into account the collected transmit power information of the coordinated points. More specifically, when the transmit power of a neighbor cell does not satisfy the predetermined transmit power condition, the neighbor cell can be excluded from the CoMP measurement set, resulting in effectively reduced interference variation. Accordingly, the user throughput degradation due to the employment of CoMP can be reduced. In addition, since unnecessary measurement and reporting of the CSI for a neighbor cell can be avoided when the transmit power of a neighbor cell does not satisfy the predetermined transmit power condition, the CSI-RS configuration at the network side is simplified for a CoMP measurement set with a small size. Correspondingly, the CSI measurement can be simplified and the CSI feedback overhead can be also reduced.

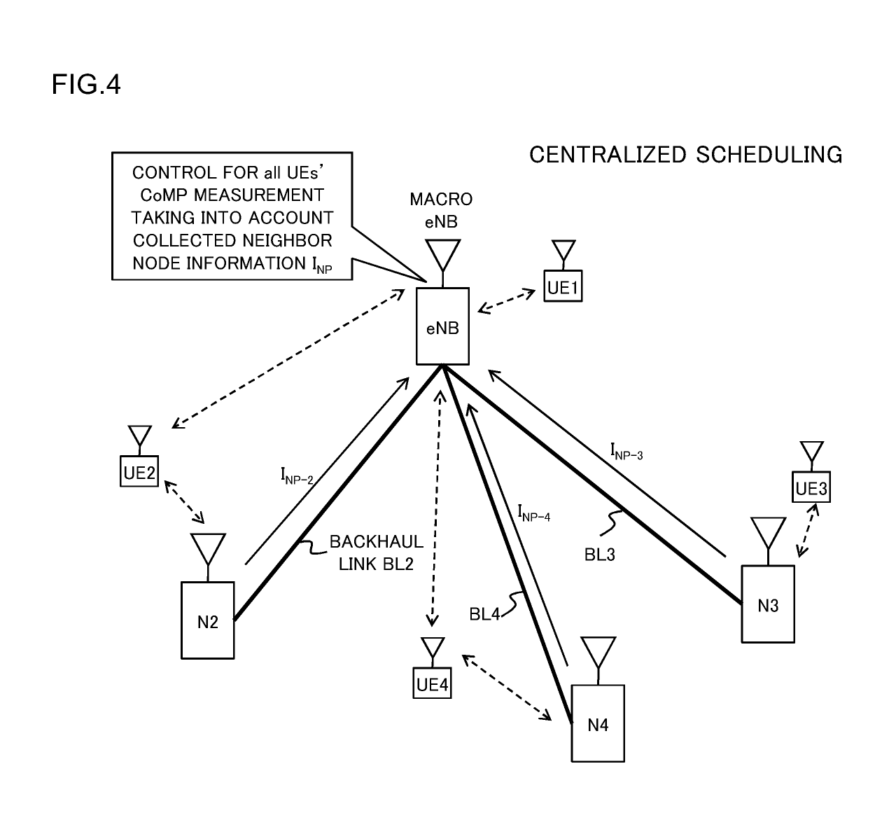

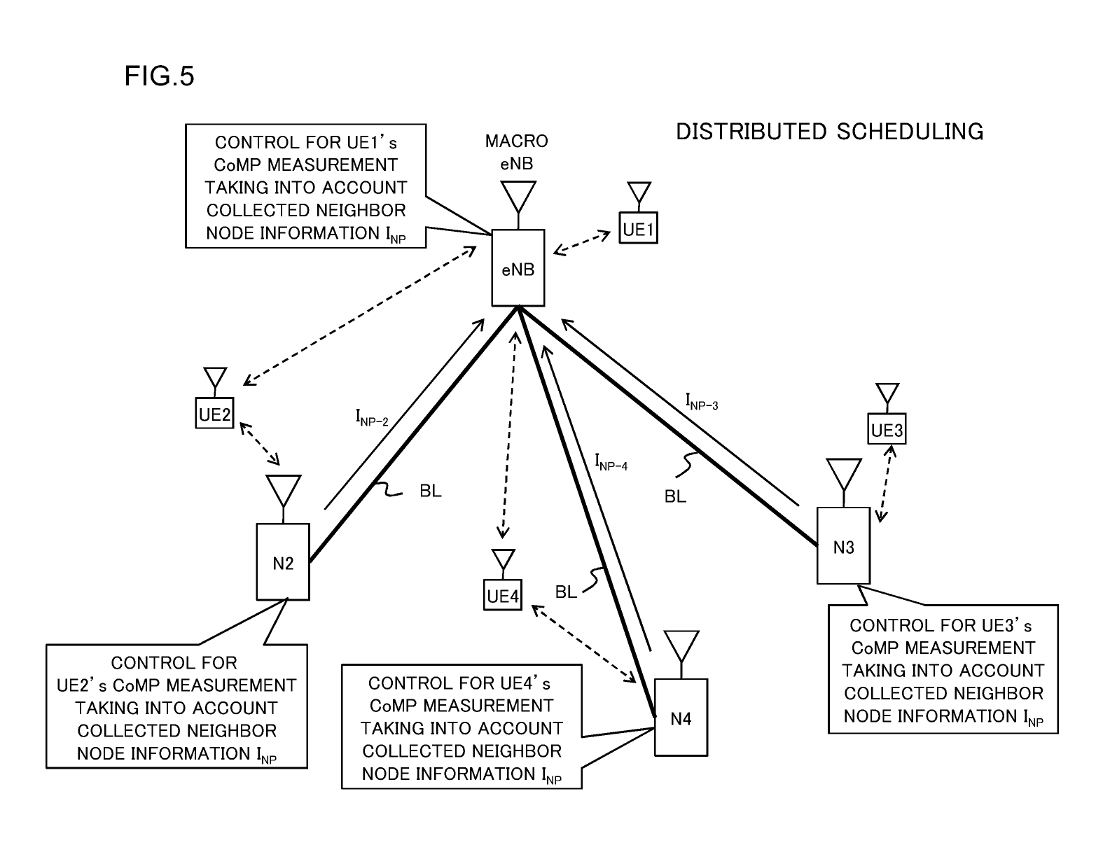

The coordinated scheduling according to the embodiment can be implemented in a centralized scheduling system as shown in FIG. 4 or a distributed scheduling system as shown in FIG. 5. In other words, the functions of the centralized scheduling can also be distributed into multiple nodes.

Referring to FIG. 4, it is assumed for simplicity that the centralized scheduling system includes a predetermined radio node (Macro eNB) and multiple radio nodes (N2-N4). Here, the Macro eNB is connected to nodes N2-N3 through backhaul links BL2-BL4 respectively and user equipments UE1-UE4 are served by the Macro eNB and the nodes N2-N4, respectively. The Macro eNB is provided with a centralized scheduler which performs the coordinated scheduling for all UE's CoMP measurement taking into account the neighbor node information I_{NP-2}−I_{NP-4} collected from neighbor nodes (here, N2-N4). The details of the coordinated scheduling in the centralized scheduling system will be described later.

Referring to FIG. 5, it is also assumed for simplicity that the distributed scheduling system includes multiple radio nodes (Macro eNB, nodes N2-N4). Here, the Macro eNB is connected to nodes N2-N3 through backhaul links BL2-BL4 respectively and user equipments UE1-UE4 are served by the Macro eNB and the nodes N2-N4, respectively. In the distributed scheduling system, not only the Macro eNB but also each of the nodes N2-N4 are provided with a distributed scheduler which is capable of communicating with other distributed schedulers. Each distributed scheduler performs the coordinated scheduling for each serving UE's CoMP measurement decision taking into account the neighbor node information {I_{NP}} collected from neighbor nodes. For instance, the distributed scheduler at the Macro eNB performs control for CoMP measurement decision of UE1 taking into account the neighbor node information I_{NP-2}−I_{NP-4} collected from neighbor nodes (here, N2-N4). Similarly, the distributed scheduler at the node N2 performs control for CoMP measurement decision of UE2 taking into account the neighbor node information I_{NP} collected from neighbor nodes (e.g. Macro eNB, nodes N3 and N4).

Hereafter, embodiments and examples of the present invention will be explained taking as an example the case of the centralized scheduling. As described above, the functions of the centralized scheduling can also be implemented in the distributed scheduling system. The embodiments and examples used to describe the principles of the present invention are by way of illustration only and should not be construed in any way to limit the scope of the disclosure. Those skilled in the art will understand that the principles of the present disclosure may be implemented in any suitably arranged wireless network. In this technical area, a point and a cell may have same meaning, so serving point and cooperating point can be interpreted as serving cell and cooperating cell, respectively.

### 2. FIRST EXEMPLARY EMBODIMENT

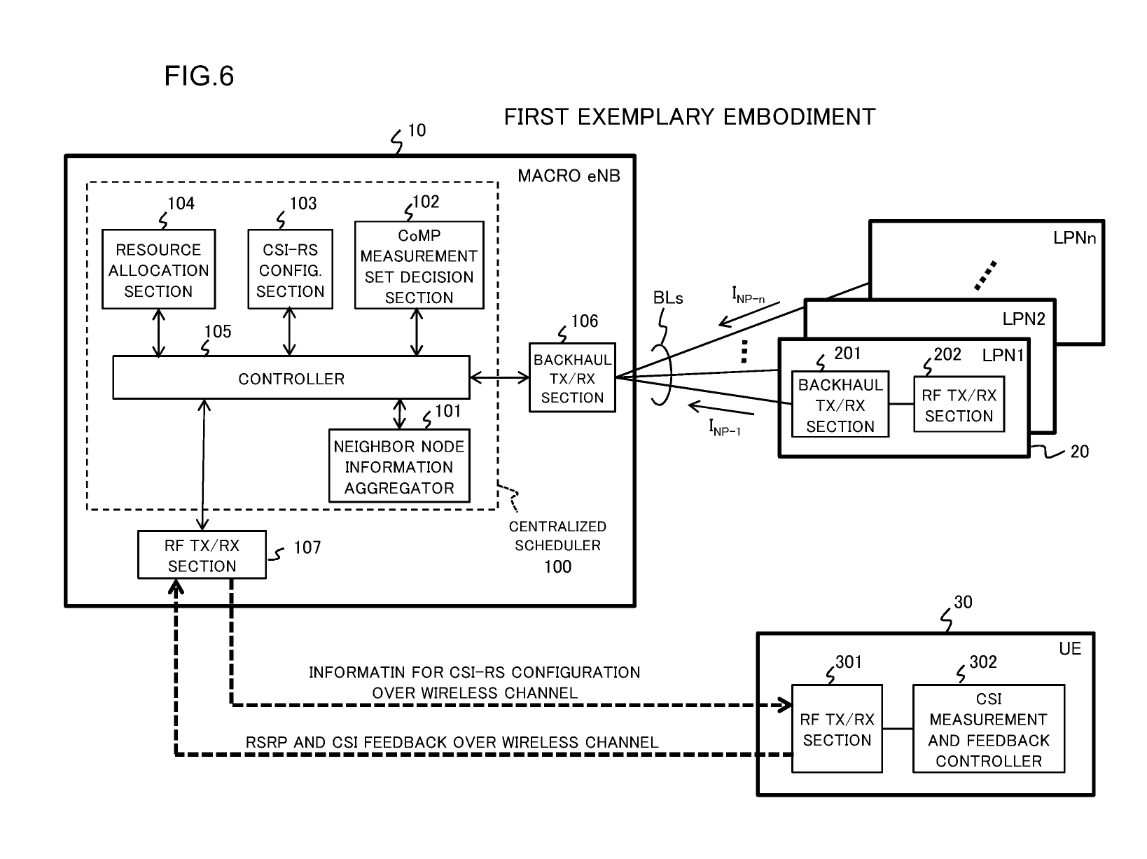

Referring to FIG. 6, a radio communication system according to a first exemplary embodiment is composed of a plurality of radio nodes (points) including Macro eNB 10, multiple nodes 20 (hereinafter, referred to as LPN1-LPNn) and user equipments UEs. Each UE is served by its serving point which is one of the Macro eNB 10 and the LPN1-LPNn. Here, it is assumed that the Macro eNB 10 is a serving point of a UE 30. The Macro eNB 10 and the LPN1-LPNn may have different transmit power levels, wherein the transmit power level of the Macro eNB 10 is higher than that of each LPN. For instance, the LPN is a low power node, picocell node, relay node or the likes. The Macro eNB 10 and each of the LPN1-LPNn are connected by a backhaul link BL (e.g. optical fiber). A communication link such as X2 backhaul and wireless link can be used in place of the backhaul link BL.

A centralized scheduler 100 is located in the Macro eNB 10 for coordinated scheduling of the Macro eNB 10 and the LPN1-LPNn. The centralized scheduler 100 is composed of a neighbor node information aggregator 101, a CoMP measurement set decision section 102, a CSI-RS configuration section 103, a resource allocation section 104 and a controller 105. The Macro eNB 10 is provided with a backhaul Tx/Rx section 106 for communicating with the LPN1-LPNn over the backhaul links and a RF Tx/Rx section 107 for communicating with a UE 30 served by the Macro eNB 10 over wireless channel.

The neighbor node information aggregator 101 collects the neighbor node information {I_{NP}} including the transmit power information from multiple points (LNP1-LPNn) to carry out the transmit power comparison. The neighbor node information I_{NP} of each LPN is sent from the backhaul Tx/Rx section 201 of each LPN to the backhaul Tx/Rx section 106 of the Macro eNB 10 over the backhaul link BL. The CoMP measurement set decision section 102 uses not only RSRP but also the neighbor node information {I_{NP}} including the transmit power information for CoMP measurement set decision. How to make use of the neighbor node information {I_{NP}} at the CoMP measurement set decision section 102 will be described later.

Each of the LPN1-LPNn is provided with a backhaul Tx/Rx section 201 for communicating with the Macro eNB 10 and a RF Tx/Rx section 202 for communicating with UEs. The UE 30 is provided with a RF Tx/Rx section 301 and a CSI measurement and feedback controller 302. The RF Tx/Rx section 301 performs radio communication with a serving point which is one of the Macro eNB 10 and the LPN1-LPNn. The CSI measurement and feedback controller 302 measures the CSI according to the informed CSI-RS configuration and feeds the RSRP and CSI back through the RF Tx/Rx section 301.

Since the RSRP measurement at each UE is reported only to its serving point, the RSRP measurements at UEs served by LPNs are collected from their serving LPNs to the centralized scheduler 100 at the Macro eNB 10 over the backhaul links. Based on such RSRP information and the neighbor node information {I_{NP}} collected by the neighbor node information aggregator 101, the CoMP measurement set decision section 102 decides the CoMP measurement set for the UE. Accordingly, the CSI-RS configuration section 103 configures the CSI-RSs for signal and interference measurement of the selected point(s) included in the UE-specific CoMP measurement set. The CSI-RS configuration of multiple coordinated points is required to be shared between the coordinated points over the backhaul links for CSI-RS transmission of each point. Accordingly, the controller 105 informs the UE of the CSI-RS configuration related to the UE's coordinated points directly or via its serving point (LPN). Since the UE30 is served by the Macro eNB 10, the UE 30 is directly received from the Macro eNB 10 through its wireless channel.

Base on the informed CSI-RS configuration, the UE 30 can measure the required CSI (RI/PMI/CQI) and feed RSRP and CSI back to the serving point under control of the CSI measurement and feedback controller 302. The resource allocation section 104 of the centralized scheduler 100 collects the CSI feedback of each UE from its serving point over the backhaul BL and generates resource allocation information. Also, the controller 105 informs each LPN of the allocated resource information through the backhaul BL. Accordingly, each LPN transmits or receives data over the allocated resources.

Alternatively, the CoMP measurement set decision section 102 of the centralized scheduler 100 uses only the RSRP for CoMP measurement set decision as conventionally. The resource allocation section 104 can use the CSI feedback of each UE and the neighbor node information {I_{NP}} including the transmit power information collected by the neighbor node information aggregator 101 to generate the resource allocation information. How to make use of the neighbor node information {I_{NP}} at the resource allocation section 104 will be described later.

As described before (see FIG. 5), the functions of the centralized scheduler 100 can also be distributed into multiple points. A UE's serving point can be equipped with the CoMP measurement set decision section 102 for deciding its CoMP measurement set. The resource allocation section 104 can also be located in each point to carry out distributed scheduling and exchange the scheduling information over backhaul link BL.

Based on the above-described system, four examples will be described hereinafter for illustration of the present invention. In these examples, the neighbor node information related to several points' transmit power is collected at one point to carry out the transmit power comparison at this point only. For better understanding, each embodiment is illustrated by two examples; respectively

### 2.1) FIRST EXAMPLE

According to the first example, CoMP measurement set decision is made by using the RSRP and transmit power PTX at coordinated points. Such PTX information is collected by the neighbor node information aggregator 101 and is used for CoMP measurement set decision at the CoMP measurement set decision section 102.

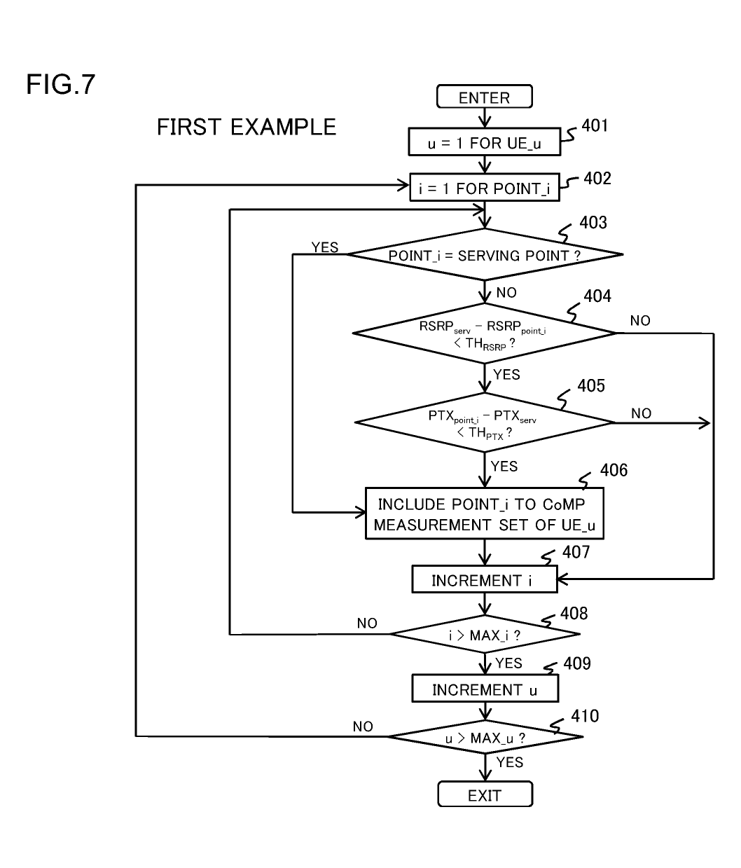

Referring to FIG. 7, the process of CoMP measurement set decision is started from initialization of UE index u for UE_u and point index i for point_i in CoMP cooperating set by resetting u and i to 1 (operations 401 and 402). Thereafter, it is checked whether point_i is the UE_u's serving point or not (operation 403). If point_i is not the UE_u's serving point (operation 403; NO), it is further checked whether the difference between the serving cell's RSRPₛₑᵣᵥ and point_i's RSRPₚₒᵢₙₜ_{_{—}}ᵢ is smaller than a predefined RSRP threshold, TH_{RSRP} (operation 404). If RSRPₛₑᵣᵥ−RSRPₚₒᵢₙₜ_{_{—}}ᵢ<TH_{RSRP} (operation 404; YES), it is further checked whether the difference between the point_i's transmit power, PTXₚₒᵢₙₜ_{_{—}}ᵢ, and the serving point's transmit power, PTXₛₑᵣᵥ, is smaller than a predefined tx power threshold, TH_{PTX} (operation 405). If PTXₚₒᵢₙₜ_{_{—}}ᵢ−PTXₛₑᵣᵥ<TH_{PTX} (operation 405; YES), the point_i is added to the CoMP measurement set of UE_u (operation 406). If point_i is the UE_u's serving point (operation 403; YES), the point_i is added to the CoMP measurement set of UE_u (operation 406) without doing the operations 404 and 405. Thereafter, point index i is incremented by one (operation 407). If RSRPₛₑᵣᵥ−RSRPₚₒᵢₙₜ_{_{—}}ᵢ>=TH_{RSRP} (operation 404; NO) or PTXₚₒᵢₙₜ_{_{—}}ᵢ−PTXₛₑᵣᵥ>=TH_{PTX} (operation 405; NO), point index i is incremented by one (operation 407) without doing the operation 406. Then it is checked whether point index i exceeds a predefined maximum value MAX_i, i.e., the maximum number of the points in the CoMP cooperating set, (operation 408) and the operations 403-408 are repeated until point index i exceeds the maximum value MAX_i (operation 408; YES). Thereafter, UE index u is incremented by one (operation 409) and then it is checked whether UE index u exceeds a predefined maximum value MAX_u, i.e., the maximum number of the UEs served by the points in the CoMP cooperating set, (operation 410) and the operations 402-409 are repeated until UE index u exceeds the maximum value MAX_u (operation 410; YES). In this manner, for each UE, the operations 403-406 are carried out for every point, by which the CoMP measurement set is finally decided.

Alternatively, instead of the relative TX power difference, PTXₚₒᵢₙₜ_{_{—}}ᵢ−PTXₛₑᵣᵥ, in the operation 405, an absolute TX power value can be used with a pre-defined TX power threshold TH_{PTX}, which is set to be an absolute transmit power level. Specifically, the operation 405 is to check whether the point_i's transmit power, PTXₚₒᵢₙₜ_{_{—}}ᵢ is smaller than the predefined TX power threshold, TH_{PTX} as PTXₚₒᵢₙₜ_{_{—}}ᵢ<TH_{PTX}.

In the first example as described above, the TX power threshold TH_{PTX} is preferably adjusted depending on the magnitude of a traffic load to achieve maximum CoMP gain. For example, in case of a higher traffic load, a higher TH_{PTX} is set such that a point with relatively or absolutely high TX power can be included into the CoMP measurement set and participate in the CoMP transmission. On the contrary, in case of a lower traffic load, a lower TH_{PTX} is needed to exclude a point with relatively or absolutely higher TX power out of the CoMP measurement set so as to avoid a significant impact on the other UEs. For adjusting TH_{PTX}, the information of coordinated points' traffic load may be used at the centralized scheduler 100. Such traffic load information can be obtained from each neighbor node through a backhaul link.

### 2.2) SECOND EXAMPLE

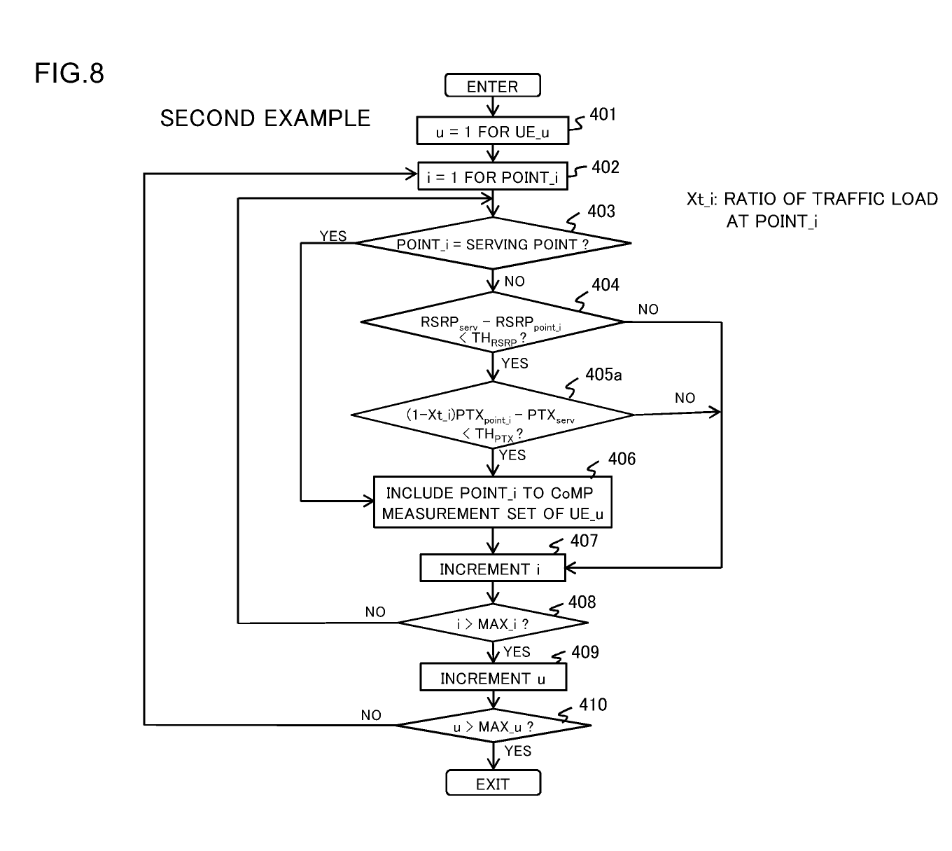

According to the second example, the CoMP measurement set decision is made by using the RSRP and transmit power PTX taking into account traffic loads at coordinated points. Such PTX and traffic load information may be collected by the neighbor node information aggregator 101 and used for CoMP measurement set decision by the CoMP measurement set decision section 102. The CoMP measurement set decision process will be described with the reference to FIG. 8, where the operations similar to the first example are denoted by the same reference numerals as those of FIG. 7.

Referring to FIG. 8, the operation 405a is different from the operation 405 of FIG. 7. If RSRPₛₑᵣᵥ−RSRPₚₒᵢₙₜ_{_{—}}ᵢ<TH_{RSRP} (operation 404; YES), it is checked whether the difference between the weighted transmit power of point_i and the serving point's transmit power, PTXₛₑᵣᵥ, is smaller than a predefined TX power threshold, TH_{PTX} (operation 405a). The weighted transmit power of point_i is defined as the transmit power PTXₚₒᵢₙₜ_{_{—}}ᵢ weighted by (1−Xt_i), wherein Xₚₒᵢₙₜ_{_{—}}ᵢ is the ratio of traffic load at point_i with 0<=Xt_i<=1. Accordingly, the weighted transmit power (1−Xt_i)PTXₚₒᵢₙₜ_{_{—}}ᵢ is regarded as the unused transmit power or transmit power available to CoMP at point_i.

If (1−Xt_i)PTXₚₒᵢₙₜ_{_{—}}ᵢ−PTXₛₑᵣᵥ<TH_{PTX} (operation 405a; YES), the point_i is included into the CoMP measurement set of UE_u (operation 406). Since the other operations 401-404 and 406-410 are similar to those of the first example, the details are omitted.

Alternatively, instead of the relative TX power difference, (1−Xt_i)PTXₚₒᵢₙₜ_{_{—}}ᵢ−PTXₛₑᵣᵥ, in the operation 405a, an absolute TX power value can be used with a pre-defined TX power threshold TH_{PTX}, which is set to be an absolute transmit power level. Specifically, the operation 405a is to check whether the point_i's weighted transmit power, (1−Xt_i)PTXₚₒᵢₙₜ_{_{—}}ᵢ, is smaller than TH_{PTX} as (1−Xt_i)PTXₚₒᵢₙₜ_{_{—}}ᵢ<TH_{PTX}.

In the second example as described above, the TX power threshold TH_{PTX} is a stable value and therefore it may not be frequently adjusted according to the changing traffic load.

### 2.3) THIRD EXAMPLE

According to the third example, resource allocation is made by using transmit power PTX at coordinated points on the conventionally decided CoMP measurement set. Such PTX information is collected by the neighbor node information aggregator 101 and is used for the channel-dependent resource allocation by the resource allocation section 104.

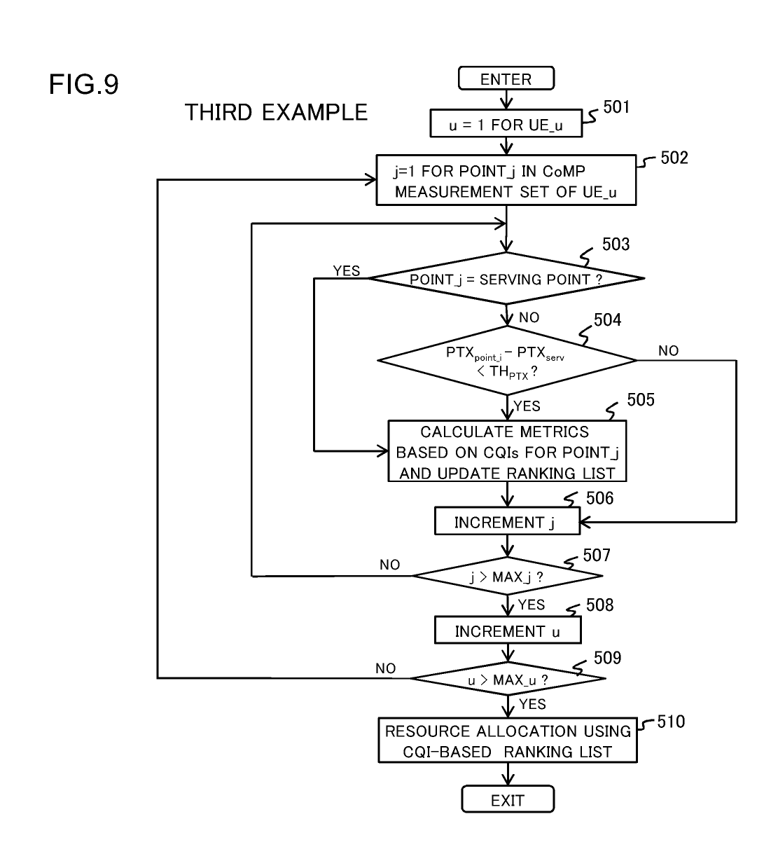

Conventionally, the channel-dependent scheduling is based on the ranking of different UEs' CQIs or achievable data rates calculated by using the CQIs. According to the third example, the point's transmit power is used to decide whether the reported CQI of a specific point can take part in the CQI-based ranking. Each resource block is allocated to the UE with highest metric calculated as a function of CQI. Before looking for the highest metric by using UE's feedback CQIs, it is required to decide whether the transmit power of the points in the UE's CoMP measurement set satisfies a predetermined condition. How to make use of the information of coordinated points' transmit power will be illustrated with reference to FIG. 9.

Referring to FIG. 9, the process of resource allocation is started from the initialization of UE index u for UE_u and point index j for the point_j in CoMP measurement set of the UE_u by resetting u and j to 1 (operations 501 and 502). The CoMP measurement set may be already decided by the conventional process, e.g., RSRP-based. Thereafter, it is checked whether point_j is the UE_u's serving point or not (operation 503). If point_j is not the UE_u's serving point (operation 503; NO), it is further checked whether the difference between the serving cell's PTXₛₑᵣᵥ and point_j's PTXₚₒᵢₙₜ_{_{—}}ᵢ is smaller than a predefined PTX threshold, TH_{RSRP} (operation 504). If PTXₚₒᵢₙₜ_{_{—}}ᵢ−PTXₛₑᵣᵥ<TH_{PTX} (operation 504; YES), the scheduling metrics are calculated based on the UE_u's feedback CQI for the point_j and the ranking list is updated (operation 505). Accordingly, the CQI-based scheduling metrics of point_j are added to the ranking list. If point_j is the UE_u's serving point (operation 503; YES), the scheduling metrics are calculated based on the UE_u's feedback CQI for the point_j and the ranking list is updated (operation 505) without doing the operation 504. Thereafter, point index j is incremented by one (operation 506). If PTXₚₒᵢₙₜ_{_{—}}ⱼ−PTXₛₑᵣᵥ>=TH_{PTX} (operation 504; NO), point index j is incremented by one (operation 506) without doing the operation 505. Then it is checked whether point index j exceeds a predefined maximum value MAX_j, i.e., the maximum number of the points in the UE_u's CoMP measurement set, (operation 507) and the operations 503-506 are repeated until point index j exceeds the maximum value MAX_j (operation 507; YES). Thereafter, UE index u is incremented by one (operation 508) and then it is checked whether UE index u exceeds a predefined maximum value MAX_u (operation 509) and the operations 502-508 are repeated until UE index u exceeds the maximum value MAX_u (operation 509; YES). In this manner, for each UE, the operations 503-506 are carried out for every point in its CoMP measurement set. When the above process has been carried out for every UE in the CoMP cooperating set, the resource allocation is performed by allocating the resource blocks based on the CQI-based ranking list (operation 510).

Alternatively, instead of the relative TX power difference, PTXₚₒᵢₙᵢ_{_{—}}ⱼ−PTXₛₑᵣᵥ, in the operation 504, an absolute TX power value can be used with a pre-defined TX power threshold TH_{PTX}, which is set to be an absolute transmit power level. Specifically, the operation 405 is to check whether the point_j's transmit power, PTXₚₒᵢₙₜ_{_{—}}ⱼ is smaller than the predefined TX power threshold, TH_{PTX} as PTXₚₒᵢₙₜ_{_{—}}ᵢ<TH_{PTX}.

In the second example as described above, the TX power threshold TH_{PTX} is preferably adjusted depending on the magnitude of traffic load to achieve maximum CoMP gain. For example, in case of higher traffic load, a higher TH_{PTX} is set such that a point with relatively or absolutely high TX power can be included into the CoMP measurement set and participate in the CoMP transmission. On the contrary, in case of lower traffic load, a lower TH_{pTx} is needed to exclude a point with relatively or absolutely higher TX power out of the CoMP measurement set so as to avoid a significant impact on the other UEs. For adjusting TH_{PTX}, the information of coordinated points' traffic load may be used at the centralized scheduler 100. Such traffic load information can be obtained from each neighbor node through a backhaul link.

### 2.4) FOURTH EXAMPLE

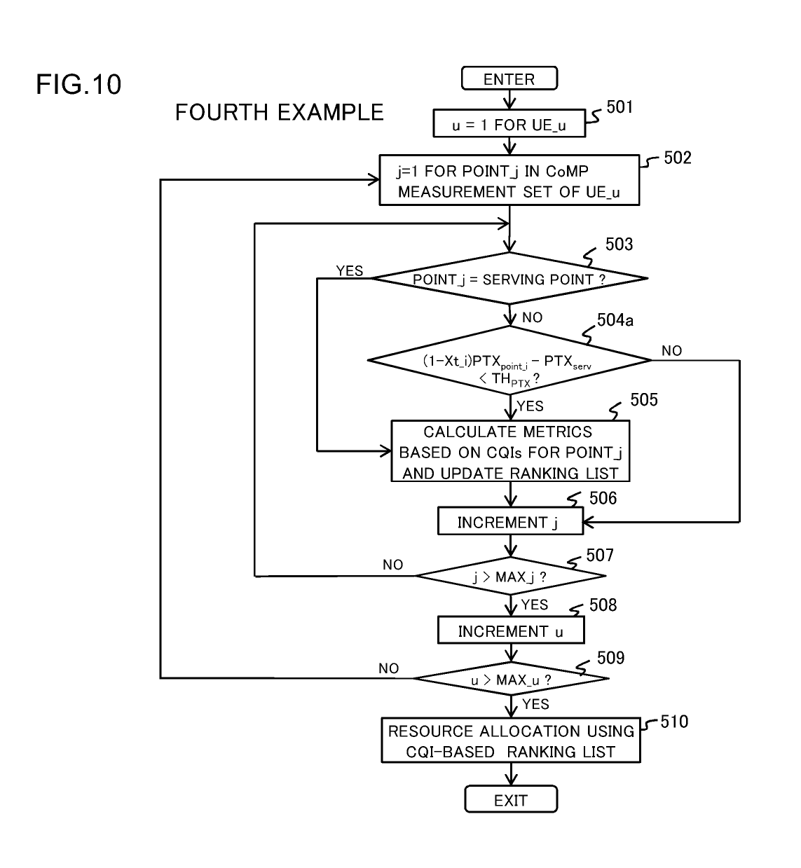

According to the fourth example, resource allocation is made by using transmit power PTX taking into account traffic loads at coordinated points on the conventionally decided CoMP measurement set. Such PTX and traffic load information may be collected by the neighbor node information aggregator 101 and used for channel-dependent resource allocation by the resource allocation section 104. The resource allocation process will be described with reference to FIG. 10, where the operations similar to the third example are denoted by the same reference numerals as those of FIG. 9.

Referring to FIG. 10, the operation 504a is different from the operation 504 of FIG. 9. If point_j is not the UE_u's serving point (operation 503; NO), it is further checked whether the difference between the weighted transmit power of point_j and the serving point's transmit power, PTXₛₑᵣᵥ, is smaller than a predefined TX power threshold, TH_{PTX} (operation 504a). The weighted transmit power of point_j is defined as the transmit power PTX ₚₒᵢₙₜ_{_{—}}ⱼ weighted by (1−Xt_j), wherein Xt_j is the ratio of traffic load at point_j with 0<=Xt_j<=1. Accordingly, the weighted transmit power (1−Xt_j)PTXₚₒᵢₙₜ_{_{—}}ⱼ is regarded as unused transmit power or transmit power available to CoMP at point_j.

If (1−Xt_i)PTXₚₒᵢₙₜ_{_{—}}ᵢ−PTXₛₑᵣᵥ<TH_{PTX} (operation 504a; YES), the scheduling metrics are calculated based on the UE_u's feedback CQI for the point_j and the ranking list is updated (operation 505). Since the other operations 501-503 and 505-510 are similar to those of the third example, the details are omitted.

Alternatively, instead of the relative TX power difference, (1−Xt_j)PTXₚₒᵢₙₜ_{_{—}}ⱼ−PTXₛₑᵣᵥ, in the operation 504a, an absolute TX power value can be used with a pre-defined TX power threshold TH_{PTX}, which is set to be an absolute transmit power level. Specifically, the operation 405a is to check whether the point_j's weighted transmit power, (1−Xt_j)PTXₚₒᵢₙₜ_{_{—}}ⱼ, is smaller than TH_{PTX}: (1−Xt_j)PTXₚₒᵢₙₜ_{_{—}}ⱼ<TH_{PTX}.

In the fourth example as described above, the TX power threshold TH_{PTX} is a stable value and therefore it may not be frequently adjusted according to the changing traffic load.

### 3. SECOND EXEMPLARY EMBODIMENT

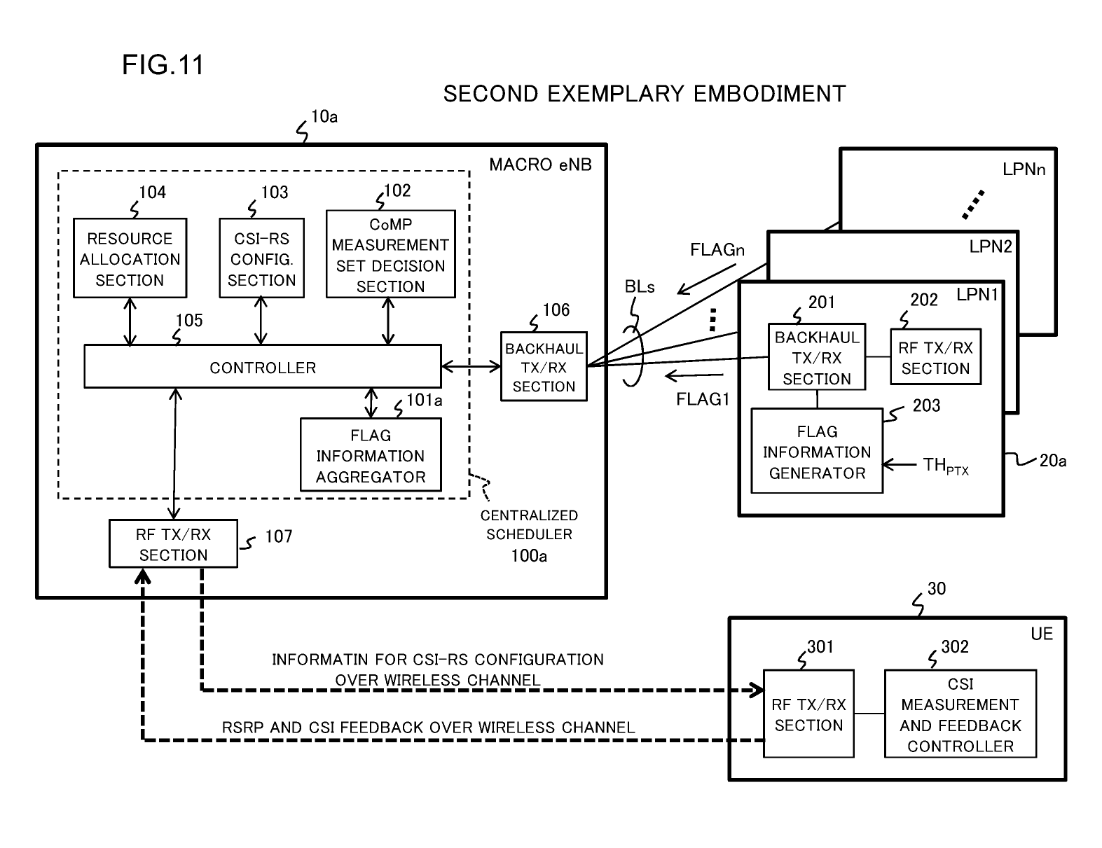

In order to further reduce the overhead for collecting the neighbor point information over backhaul links BL, especially in the case where the LPN1-LPNn are connected to the Macro eNB 10 by X2 backhaul, the TX power comparison is carried out at each point independently and only the comparison results of several points are sent to one point for final decision. The coordinated scheduling according to the second exemplary embodiment will be described with reference to FIG. 11, where blocks having functions similar to the first exemplary embodiment are denoted by the same reference numerals as those in FIG. 6.

Referring to FIG. 11, the centralized scheduler 100a and LPN 20a are different from the centralized scheduler 100 and LPN 20 of FIG. 6. The centralized scheduler 100a is located in a Macro eNB 10a for coordinated scheduling of the Macro eNB 10a and the LPN 20a (LPN1-LPNn). The centralized scheduler 100a has a flag information aggregator 101a in place of the neighbor node information aggregator 101 of FIG. 6. Correspondingly, a flag information generator 203 is included in the LPN 20a. The flag information generator 203 compares the transmit power PTX of the LPN 20a with a pre-defined TX power threshold TH_{PTX} to generate a flag representing the comparison result. The pre-defined TX power threshold TH_{PTX} may be set according to the higher-layer signaling, e.g., RRC signaling, at each LPN 20a or may be informed from the Macro eNB 20a to each LPN 20a. The LPN 20a transmits the flag to the Macro eNB 10a through the backhaul BL. In this manner, the flab information aggregator 101a of the Macro eNB 10a collects flags FLAG1-FLAGn from the LPN1-LPNn. The CoMP measurement set decision section 102 decides CoMP measurement set based on the collected flags and RSRP information. The CoMP measurement set decision section 102 uses not only the RSRP but also the collected flags FLAG1-FLAGn for the CoMP measurement set decision. How to make use of the flag information at the CoMP measurement set decision section 102 will be described later.

### 3.1) FIFTH EXAMPLE

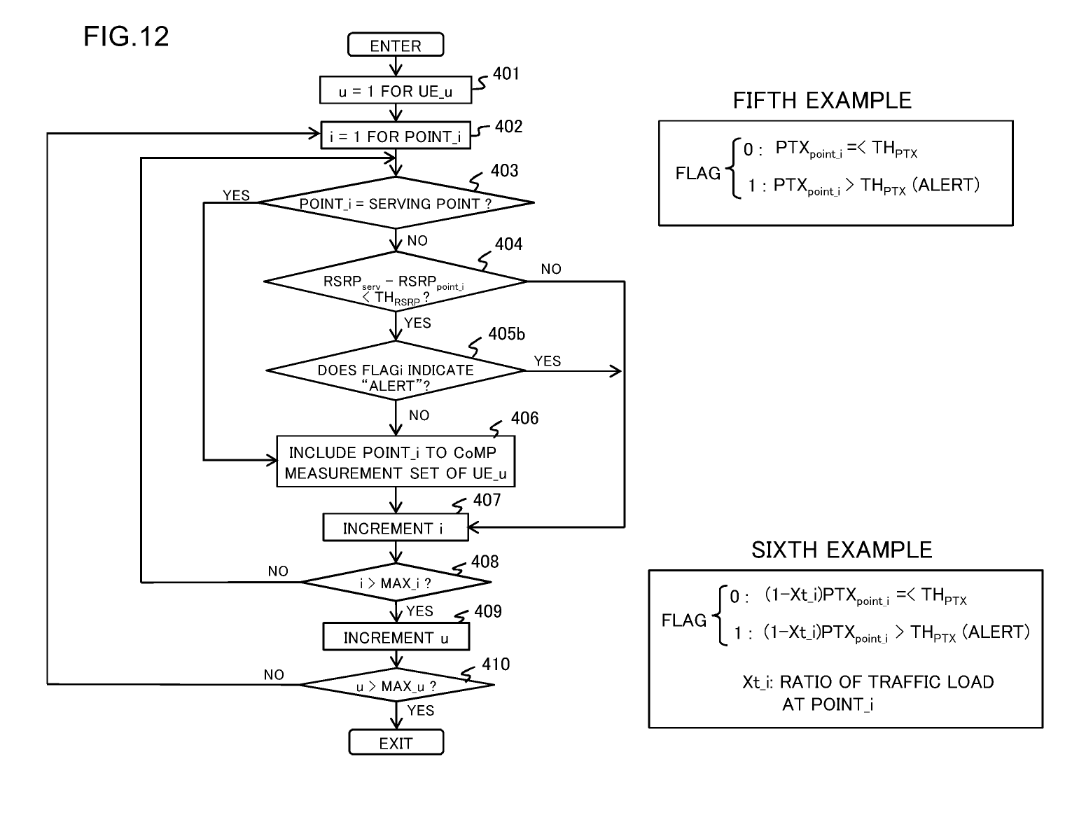

As shown in FIG. 12, at each LPN 20a indicated by point_i, the flag information generator 203 compares its own transmit power PTXₚₒᵢₙₜ_{_{—}}ᵢ with the pre-defined TX power threshold TH_{PTX} to generate a flag representing the comparison result. In this example, the FLAGi is set to “0” when PTXₚₒᵢₙₜ_{_{—}}ᵢ=<TH_{PTX}. The FLAGi is set to “1” when PTXₚₒᵢₙₜ_{_{—}}ᵢ>TH_{PTX} which means “ALERT”. In other words, when the transmit power PTXₚₒᵢₙₜ_{_{—}}ᵢ exceeds the pre-defined TX power threshold TH_{PTX}, the point_i is likely to have a significant impact on other UEs and therefore the point_i should not be included into the CoMP measurement set. Such flag information FLAG is sent to the Macro eNB 10a. From the viewpoint of further reduction in overhead of information exchange, It is preferable that only when FLAG=“ALERT”, the flag information FLAG is sent to the Macro eNB 10a.

At the CoMP measurement set decision section 102, the CoMP measurement set decision is made by using the RSRP and the collected flag information FLAGs. The CoMP measurement set decision process is described with reference to FIG. 12, where the operations similar to the first example are denoted by the same reference numerals as those of FIG. 7.

Referring to FIG. 12, the operation 405b is different from the operation 405 of FIG. 7. If RSRPₛₑᵣᵥ−RSRPₚₒᵢₙₜ_{_{—}}ᵢ<THRSRP (operation 404; YES), it is checked whether the flag information FLAGi =“1” (operation 405b). If FLAGi=“1” (operation 405b; NO), the point_i is included into the CoMP measurement set of UE_u (operation 406). If FLAGi=“0” (operation 405b; YES), the operation 406 is skipped. Since the other operations 401-404 and 406-410 are similar to those of the first example, the details are omitted.

In the fifth example as described above, the TX power threshold TH_{PTX} is preferably adjusted depending on the magnitude of traffic load to achieve maximum CoMP gain. For example, in case of a higher traffic load, a higher TH_{PTX} is set such that a point with relatively or absolutely high TX power can be included into the CoMP measurement set and participate in the CoMP transmission. On the contrary, in case of a lower traffic load, a lower TH_{PTX} is needed to exclude a point with relatively or absolutely higher TX power out of the CoMP measurement set so as to avoid a significant impact on the other UEs. For adjusting TH_{PTX}, the information of coordinated points' traffic load may be used at the centralized scheduler 100. Such traffic load information can be obtained from each neighbor node through a backhaul link.

### 3.2) SIXTH EXAMPLE

According to the sixth example, CoMP measurement set decision is made by using the RSRP and transmit power PTX taking into account traffic loads at coordinated points.

As shown in FIG. 12, at each LPN 20a indicated by point_i, the flag information generator 203 compares its own weighted transmit power (1−Xt_I)PTXₚₒᵢₙₜ_{_{—}}ᵢ with the pre-defined TX power threshold TH_{PTX} to generate a flag representing the comparison result. In this example, FLAGi is set to “0” when (1−Xt_i)PTXₚₒᵢₙₜ_{_{—}}ᵢ=<TH_{PTX}. FLAGi is set to “1” when (1−Xt_i)PTXₚₒᵢₙₜ_{_{—}}ᵢ>TH_{PTX} which means “ALERT”. As described before, Xt_i is the ratio of traffic load at point_i with 0<=Xt_i<=1. Accordingly, the weighted transmit power (1−Xt_i)PTXₚₒᵢₙₜ_{_{—}}ᵢ is regarded as unused transmit power or transmit power available to CoMP at point_i. When the weighted transmit power (1−Xt_i)PTXₚₒᵢₙₜ_{_{—}}ᵢ exceeds the pre-defined TX power threshold TH_{PTX}, the point_i is likely to have a significant impact on other UEs and therefore the point_i should not be included into the CoMP measurement set. Such flag information FLAG is sent to the Macro eNB 10a. From the viewpoint of further reduction in overhead of information exchange, It is preferable that only when FLAG=“ALERT”, the flag information FLAG is sent to the Macro eNB 10a.

The CoMP measurement set decision process according to the sixth example is the same as the fifth example as shown in FIG. 12.

In the sixth example as described above, the TX power threshold TH_{PTX} is a stable value and therefore it may not be frequently adjusted according to the changing traffic load.

### 3.3) SEVENTH EXAMPLE

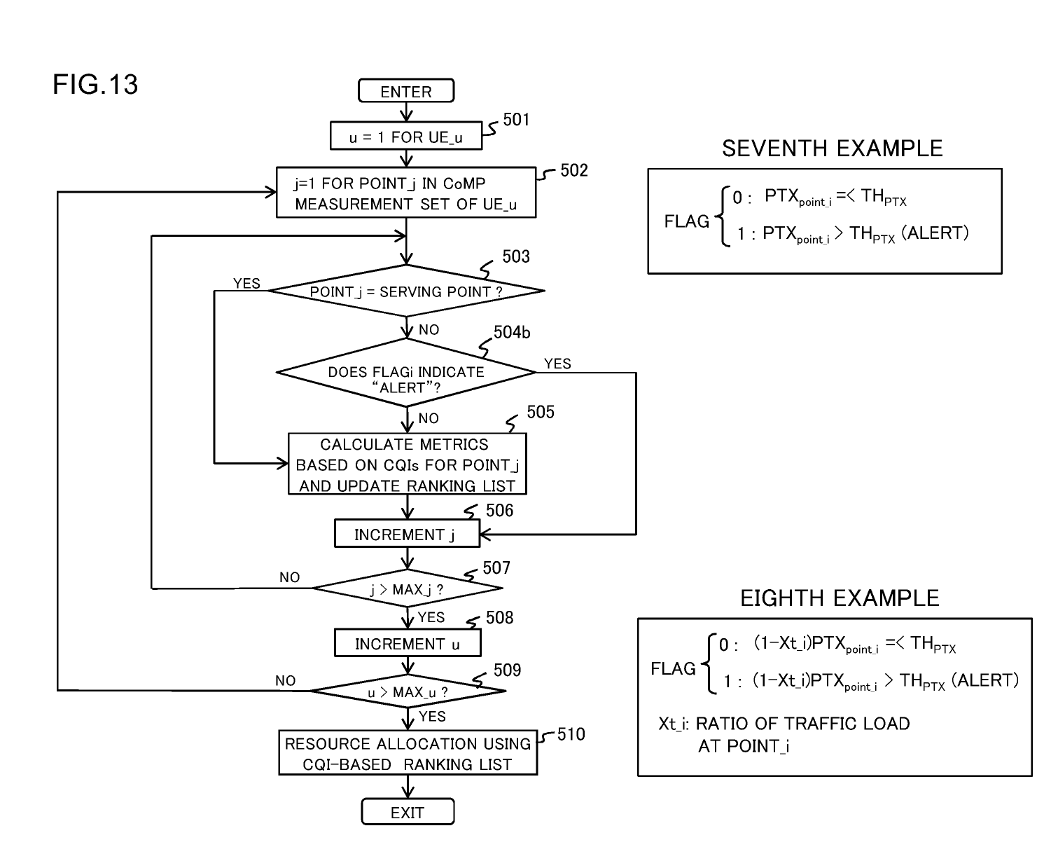

As shown in FIG. 13, at each LPN 20a indicated by point_i, the flag information generator 203 compares its own transmit power PTXₚₒᵢₙₜ_{_{—}}ᵢ with the pre-defined TX power threshold TH_{PTX} to generate a flag representing the comparison result. In this example, FLAGi is set to “0” when PTXₚₒᵢₙₜ_{_{—}}ᵢ=<TH_{PTX}. FLAGi is set to “1” when PTXₚₒᵢₙₜ_{_{—}}ᵢ>TH_{PTX} which means “ALERT”. In other words, when the transmit power PTXₚₒᵢₙₜ_{_{—}}ᵢ exceeds the pre-defined TX power threshold TH_{PTX}, the point_i is likely to have a significant impact on other UEs and therefore the point_i should not be included into the CoMP measurement set. Such flag information FLAG is sent to the Macro eNB 10a. From the viewpoint of further reduction in overhead of information exchange, It is preferable that only when FLAG=“ALERT”, the flag information FLAG is sent to the Macro eNB 10a.

According to the seventh example, the resource allocation is made by using transmit power PTX at coordinated points. Such PTX may be collected by the neighbor node information aggregator 101 and used for the channel-dependent resource allocation by the resource allocation section 104. The resource allocation process will be described with reference to FIG. 13, where the operations similar to the third example are denoted by the same reference numerals as those of FIG. 9.

Referring to FIG. 13, the operation 504b is different from the operation 504 of FIG. 9. If point_j is not the UE_u's serving point (operation 503; NO), it is checked whether the flag information FLAGi=“1” (operation 504b). If FLAGi=“1” (operation 504b; NO), the scheduling metrics are calculated based on the UE_u's feedback CQI for the point j and the ranking list is updated (operation 505). Accordingly, the CQI based scheduling metrics of are added to the ranking list. If point_j is the UE_u's serving point (operation 503; YES), the scheduling metrics are calculated based on the UE_u's feedback CQI for the point_j and the ranking list is updated (operation 505) without doing the operation 504b. If FLAGi=“0” (operation 504b; YES), the operation 505 is skipped. Since the other operations 501-503 and 505-510 are similar to those of the third example, the details are omitted.

In the seventh example as described above, the TX power threshold TH_{PTX} is preferably adjusted depending on the magnitude of traffic load to achieve maximum CoMP gain. For example, in case of a higher traffic load, a higher TH_{PTX} is set such that a point with relatively or absolutely high TX power can be included into the CoMP measurement set and participate in the CoMP transmission. On the contrary, in case of a lower traffic load, a lower TH_{PTX} is needed to exclude a point with relatively or absolutely higher TX power out of the CoMP measurement set so as to avoid a significant impact on the other UEs. For adjusting TH_{PTX}, the information of coordinated points' traffic load may be used at the centralized scheduler 100. Such traffic load information can be obtained from each neighbor node through a backhaul link.

### 3.4) EIGHTH EXAMPLE

According to the eighth example, resource allocation is made by using the transmit power PTX taking into account traffic loads at coordinated points in the conventionally decided CoMP measurement set.

As shown in FIG. 13, at each LPN 20a indicated by point_i, the flag information generator 203 compares its own weighted transmit power (1−Xt_i)PTXₚₒᵢₙₜ_{_{—}}ᵢ with the pre-defined TX power threshold TH_{PTX} to generate a flag representing the comparison result. In this example, FLAGi is set to “0” when (1−Xt_i)PTXₚₒᵢₙₜ_{_{—}}ᵢ=<TH_{PTX}. FLAGi is set to “1” when (1−Xt_i)PTXₚₒᵢₙₜ_{_{—}}ᵢ>TH^{PTX} which means “ALERT”. As described before, Xt_i is the ratio of traffic load at point_i with 0<=Xt_i<=1. Accordingly, the weighted transmit power (1−Xt_i)PTXₚₒᵢₙₜ_{_{—}}ᵢ is regarded as unused transmit power or transmit power available to CoMP at point_i. Such flag information FLAG is sent to the Macro eNB 10a. From the viewpoint of further reduction in overhead of information exchange, It is preferable that only when FLAG=“ALERT”, the flag information FLAG is sent to the Macro eNB 10a.

The resource allocation process according to the eighth example is the same as the seventh example as shown in FIG. 13.

In the eighth example as described above, the TX power threshold TH_{PTX} is a stable value and therefore it may not be frequently adjusted according to the changing traffic load.

### INDUSTRIAL APPLICABILITY

The present invention can be applied to a mobile communications system employing coordinated scheduling among multiple transmission points.

1-28. (canceled)

29. A radio communication system comprising a plurality of radio nodes each capable of communicating with a user equipment, wherein at least one radio node comprises a scheduler which collects neighbor node information from neighbor radio nodes and performs coordinated scheduling of multiple coordinated radio nodes using the neighbor node information, wherein the neighbor node information includes information related to transmit power of the neighbor radio nodes.

30. The radio communication system according to claim 29, wherein the scheduler includes or excludes a neighbor radio node from the multiple coordinated radio nodes depending on the information related to transmit power of the neighbor radio node.

31. The radio communication system according to claim 29, wherein the information related to the transmit power of the neighbor radio node is a magnitude of transmit power of the neighbor radio node.

32. The radio communication system according to claim 31, wherein the information related to the transmit power of the neighbor radio node is a magnitude of the transmit power adjusted depending on traffic load of the neighbor radio node.

33. The radio communication system according to claim 29, wherein the coordinated scheduling is performed based on a comparison result between a magnitude of transmit power of each neighbor radio node and a predetermined threshold.

34. The radio communication system according to claim 33, wherein the predetermined threshold is adjusted depending on traffic load of the neighbor radio node.

35. The radio communication system according to claim 33, wherein the information related to the transmit power of the neighbor radio nodes includes the comparison result.

36. The radio communication system according to claim 29, wherein the information related to the transmit power of coordinated radio nodes is used to decide which coordinated points are configured for measurement and reporting of channel state information (CSI) at a user equipment.

37. The radio communication system according to claim 29, wherein the information related to the transmit power of coordinated radio nodes is used for resource allocation at one or more coordinated radio node to a user equipment.

38. A method for controlling communication of a radio node in a radio communication network including a plurality of radio nodes each capable of communicating with a user equipment, comprising:
collecting neighbor node information from neighbor radio nodes; and
performing coordinated scheduling of multiple coordinated radio nodes using the neighbor node information, wherein the neighbor node information includes information related to transmit power of the neighbor radio nodes.

39. The method according to claim 38, wherein a neighbor radio node is excluded from the multiple coordinated radio nodes depending on information related to the transmit power of the neighbor radio node.

40. The method according to claim 38, wherein the information related to the transmit power of the neighbor radio node is a magnitude of the transmit power of the neighbor radio node.

41. The method according to claim 40, wherein the information related to the transmit power of the neighbor radio node is a magnitude of the transmit power adjusted depending on traffic load of the neighbor radio node.

42. The method according to claim 38, wherein the coordinated scheduling is performed based on a comparison result between a magnitude of transmit power of each neighbor radio node and a predetermined threshold.

43. The method according to claim 42, wherein the predetermined threshold is adjusted depending on the traffic load of the neighbor radio node.

44. The method according to claim 42, wherein the information related to the transmit power of the neighbor radio nodes includes the comparison result.

45. The method according to claim 38, wherein the information related to the transmit power of coordinated radio nodes is used to decide which coordinated points are configured for measurement and reporting of channel state information (CSI) at a user equipment.

46. The method according to claim 38, wherein the information related to the transmit power of coordinated radio nodes is used for resource allocation at one or more coordinated radio node to a user equipment.

47. A radio node of a radio communication network including a plurality of radio nodes each capable of communicating with a user equipment, comprising:
a scheduler which collects neighbor node information from neighbor radio nodes and performs coordinated scheduling of multiple coordinated radio nodes using the neighbor node information, wherein the neighbor node information includes information related to transmit power of the neighbor radio nodes.

48. The radio node according to claim 47, wherein the scheduler includes or excludes a neighbor radio node from the multiple coordinated radio nodes depending on information related to the transmit power of the neighbor radio node.

49. The radio node according to claim 47, wherein the information related to the transmit power of the neighbor radio node is a magnitude of the transmit power of the neighbor radio node.

50. The radio node according to claim 49, wherein the information related to the transmit power of the neighbor radio node is a magnitude of the transmit power adjusted depending on traffic load of the neighbor radio node.

51. The radio node according to claim 47, wherein the coordinated scheduling is performed based on a comparison result between a magnitude of the transmit power of each neighbor radio node with a predetermined threshold.

52. The radio node according to claim 51, wherein the predetermined threshold is adjusted depending on traffic load of the neighbor radio node.

53. The radio node according to claim 51, wherein the information related to the transmit power of the neighbor radio nodes includes the comparison result.

54. The radio node according to claim 47, wherein the information related to the transmit power of coordinated radio nodes is used to decide which coordinated points are configured for measurement and reporting of channel state information (CSI) at a user equipment.

55. The radio node according to claim 47, wherein the information related to the transmit power of coordinated radio nodes is used for resource allocation at one or more coordinated radio node to a user equipment.
